(19) United States
(12) Patent Application Publication
(10) Pub. No.: US 2023/0243186 A1
(43) Pub. Date: Aug. 3, 2023

(54) ELECTRONIC DOOR LOCK WITH KEYPAD

(71) Applicant: Lewis Hyman, Inc., Carson, CA (US)

(72) Inventor: Robert LeBlanc, Kennesaw, GA (US)

(21) Appl. No.: 18/103,826

(22) Filed: Jan. 31, 2023

Related U.S. Application Data
(60) Provisional application No. 63/305,085, filed on Jan. 31, 2022.

(51) Int. Cl. E05B 49/00; E05B 17/10; G07C 9/00

(52) U.S. Cl. CPC E05B 49/006; E05B 17/10; G07C 9/00674

(57) ABSTRACT

An electronic door lock includes a housing having a keypad window, a keypad inserted into the keypad window and having a plurality of depressible buttons, and a bezel surrounding the keypad and having a spar, the spar lying between the buttons and providing support to the plurality of depressible buttons in a direction substantially perpendicular to a press direction. The electronic door lock may also have a circuit board which detects button depressions. The housing may be constructed with a single cut designed to enclose multiple buttons, reducing manufacturing costs. The keypad may have a flexible support webbing with chambers corresponding to the buttons. Certain chambers may be connected, allowing a single LED to illuminate multiple buttons, further reducing manufacturing cost.

### CROSS-REFERENCE TO RELATED APPLICATIONS

This application claims priority to U.S. Provisional Patent Application Ser. No. 63/305,085, filed Jan. 31, 2022, entitled “ELECTRONIC DOOR LOCK WITH KEYPAD,” the disclosure of which is hereby incorporated by reference in its entirety.

### BACKGROUND

Electronic door locks are a feature of many residences, and often provide an electromechanical mechanism configured to engage and disengage a door lock. Homeowners may choose electronic door locks to enable residents and visitors to open a door without a key, for instance by entering a code on a keypad. This may be advantageous as a backup should a resident lose a key, or to grant temporary access to housekeepers or workers. Electronic door locks may provide similar benefits for businesses and vacation rentals, for example.

However, because electronic door locks are installed on the exterior of a door, if the locks aren't designed properly, sensitive internal electronics may be exposed to rain and dust, which can potentially damage the electronics and shorten the lifetime of the electronic door lock.

An additional complication is that many users prefer tactile, depressible buttons. For instance, a user may find these types of buttons easy to depress accurately in difficult lighting conditions (e.g., low light, direct sunlight, etc.). However, moveable buttons may have frictional engagement surfaces that move across an edge of a lock housing when pressed. Each of these glide surfaces may present additional points for water and dust intrusion. Traditional methods of sealing these surfaces may involve many components, increasing manufacturing costs and failure modes.

Accordingly, there is a need for electronic door locks with water- and dust-resistant depressible buttons that protect electronics and extend electronic door lock lifetimes. There is also a need for cost-effective manufacturing methods for the same.

### SUMMARY

It should be appreciated that this Summary is provided to introduce a selection of concepts in a simplified form that are further described below in the Detailed Description. This Summary is not intended to be used to limit the scope of the claimed subject matter.

According to one aspect of the disclosure, an electronic door lock may include (1) a housing having a keypad window; (2) a keypad inserted into the keypad window and having a plurality of depressible buttons; and (3) a bezel surrounding the keypad and having a spar, the spar lying between the buttons and providing support to the plurality of depressible buttons in a direction substantially perpendicular to a press direction.

According to another aspect of the disclosure, a method of manufacturing an electronic door lock may include (1) forming a keypad window in a lock housing; (2) inserting a bezel into the keypad window, the bezel comprising a plurality of spars; and (3) aligning a plurality of buttons of a keypad comprising a plurality of buttons with respective spaces between the plurality of spars. In various embodiments, the method further includes (4) inserting the keypad into the keypad window, (5) aligning webbing recesses of the keypad with respective LEDs disposed on a circuit board, and (6) securing the bezel, the keypad, and the circuit board to the lock housing.

According to an additional aspect of the disclosure, an electronic door lock may include (1) a lock body having a keypad window and substantially defining an interior volume; and (2) an elastomeric keypad disposed in the keypad window. The elastomeric keypad may include a plurality of buttons, an integrated webbing configured to provide a longitudinal reaction force to return a particular button of the plurality of buttons to a non-depressed orientation in response to the particular button being pressed; and a sealing flange substantially lying in a plane perpendicular to the longitudinal reaction force. The electronic door lock may further include (3) a circuit board disposed in the interior volume and comprising an LED. In certain embodiments, the elastomeric keypad may contact the circuit board, and the sealing flange may be positioned to prevent water from entering a volume between the elastomeric keypad and a circuit board behind the elastomeric keypad.

### BRIEF DESCRIPTION OF THE DRAWINGS

Various embodiments of the invention will be described below. In the course of the description, reference will be made to the accompanying drawings, which are not necessarily drawn to scale, and wherein:

FIGS. 1A and 1B are perspective views of an assembled electronic door lock with a keypad according to various embodiments of the present disclosure.

FIG. 2 illustrates a rear view of a keypad of the electronic door lock of FIGS. 1A and 1B.

FIG. 3 illustrates a keypad circuit board according to various embodiments of the present disclosure, which may be used, for example, within the electronic door lock of FIGS. 1A and 1B.

FIG. 4 illustrates a keypad bezel according to various embodiments of the present disclosure which may be used, for example, within the electronic door lock of FIGS. 1A and 1B.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. References to an element in the plural may include embodiments with one element. Likewise, references to an element in the singular may include embodiments having multiple elements.

For the purposes of this disclosure, the term “electronic door lock” is used to describe a door lock that may be selectively disengaged by an electromechanical locking mechanism, such as a motor or solenoid. The electronic door lock may be installed on an exterior or interior door and may selectively engage and disengage a lock component that is configured to prevent the door from opening. For instance, the lock component may be a deadbolt, and the electronic door lock may cause the deadbolt to extend into a corresponding door frame to secure the door.

Additionally, the electronic door lock may include a keyless activation device that activates the electromechanical locking mechanism to unlock or lock the deadbolt. For example, the electronic door lock may include a keypad, and a user may gain entry to a house by entering a particular code into the keypad, rather than inserting a physical key into keyhole on the lock and turning the key. The electronic door lock may also have a manual control, such as a thumb turn or keyhole, which may permit a user to selectively lock and unlock the door without action by the electromechanical locking mechanism.

In certain embodiments, a single keypad may include multiple buttons. This may reduce manufacturing costs over a design having multiple individual buttons. For example, a single keypad with multiple buttons may require managing fewer lock components than a design having many individual buttons. This may also result in a smaller bill of materials and fewer manufacturing steps, reducing overall lock cost.

Including a single keypad with multiple buttons in a single opening on a lock housing may simplify lock housing manufacturing. For instance, in certain embodiments of the present disclosure, a lock housing may be manufactured with one cut or punch to fit a keypad with multiple buttons, rather than multiple cuts or punches. This may also result in a single, continuous edge for surface finishing, rather than multiple complex edges. This reduced manufacturing complexity may result in lower error rates and fewer scrapped parts. The single, continuous edge may also provide fewer seams where water and dust may penetrate the lock housing.

Further still, electronic door locks according to various embodiments may include one or more light-emitting diodes (LEDs) which illuminate the buttons of the keypad for easier visibility. By combining multiple buttons into a single keypad, an electronic door lock may illuminate multiple buttons on the keypad with a one LED. This may result in fewer total LEDs being required to illuminate the keypad buttons, which may further reduce manufacturing steps, the lock's bill of materials, and overall cost.

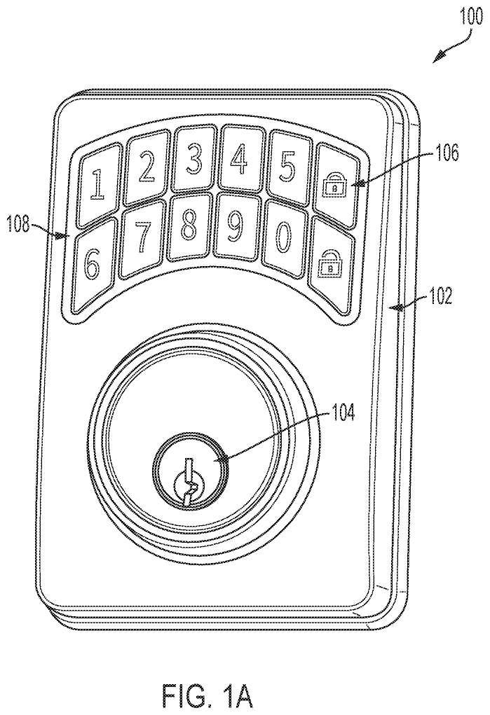

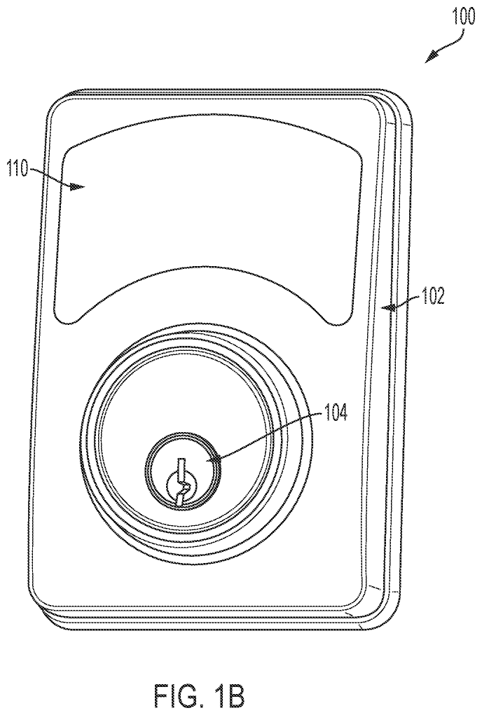

FIG. 1A illustrates a perspective view of an exterior assembly of an electronic door lock 100 according to various embodiments of the present disclosure. The electronic door lock 100 may be attached to an exterior side of a door (e.g., opening to the outside, opening to a hallway, etc.). The electronic door lock 100 may include a housing 102 made of a suitable, and in some cases weatherproof, material (e.g., metal, plastic, etc.). The housing 102 may include attachment mechanisms (e.g., fasteners) to secure the electronic door lock 100 to a door. The housing 102 may be at least substantially watertight to further protect internal lock components, such as an electromechanical locking mechanism and/or circuit board. The electronic door lock 100 may further include an internal assembly that is configured to be disposed on the inside of a door opposite the housing 102 which, when the lock is installed, cooperates with the housing 102 to secure the electronic door lock 100 to the door, and, in various embodiments, to secure additional circuit board(s) and/or components of the electromechanical locking mechanism within the electronic door lock's interior.

The electronic door lock 100 may also include a keyhole 104. The housing 102 may be configured so that, when it is installed on a door, the housing houses and protects a lock tumbler that is disposed between the housing 102 and the door and that may be selectively engaged by inserting a key into the keyhole 104. This may provide redundant entry options, for instance if batteries of the electronic door lock have insufficient charge to power the lock's electromechanical locking mechanism. In certain embodiments, the keyhole 104 may be disposed in an opening mechanism, such as a knob or handle. For example, the electronic door lock 100 may include a doorknob with the keyhole 104.

In various embodiments, the housing 102 may protect a circuit board (not shown) operatively connected to, and configured to receive signals from, the lock's keypad 106. As shown in FIGS. 1A and 1B, the keypad 106 may include a plurality of buttons which may be numbered, lettered, or have other identifying symbols, such as lock and unlock buttons. For example, in FIGS. 1A and 1B, various buttons each include a respective number or lock or unlock symbol. In various embodiments, the electronic door lock 100 is configured so that when a user selects the buttons of the keypad 106 in a correct order (e.g., the user enters a particular access code), a circuit board may send a signal that triggers the lock's electromechanical locking mechanism to unlock or lock a door on which the electronic door lock 100 is installed (e.g., by retracting or extending a dead bolt or a pin that prevents a knob or handle from rotating). In various embodiments, the buttons of the keypad 106 may be respective components of a single membrane, such as an elastomeric keypad which may, for example, be made from silicone rubber. Further, the front housing 102 may be adapted to secure a gasket (e.g., silicon or rubber) against a door surface to prevent water intrusion and damage to the circuit board. Additional aspects of the keypad 106 will be described below.

In certain embodiments, the various keys of the keypad 106 may each respectively engage with a bezel 108. The bezel 108 may provide additional structural support to the respective buttons of the keypad 106. For example, the bezel 108 may provide vertical and horizontal support to respective buttons of the keypad 106 while the buttons move longitudinally when pressed. By providing support to multiple buttons by using a single bezel, the electronic door lock 100 may have fewer required parts and a lower manufacturing cost if a separate bezel were used to support each button. Further, the bezel 108 may also help resist water and dust intrusion by at least partially sealing the perimeter of each button, as well as frictionally engaging the button as the button is being depressed and scraping dust and water off of the sides of the button. Additional aspects of the bezel will be described below.

Turning to FIG. 1B, the housing 102 of the electronic door lock 100 may include a keypad window 110. The keypad window 110 may be an opening in the housing 102 that, as shown in FIG. 1B, is dimensioned to receive the keypad 106 and the bezel 108. In certain embodiments, the keypad window 110 may be dimensioned to house a keypad 106 having multiple depressible buttons. As a result, a number of windows on the housing 102 may be less than a number of buttons on the keypad 106.

In various embodiments, the keypad window 110 may be formed in the housing 102 efficiently during assembly. For example, tools used to cut the keypad window may be larger and thus more durable than if the keypad window 110 were sized smaller to house only one button. For instance, the keypad window 110 may be punched in a machine press, cut, 3D printed, or forged in place during manufacturing. A larger keypad window 110 may be created by larger tools (i.e., drills, dies, etc.) having greater durability than smaller tools, reducing tool consumption and manufacturing cost. In certain embodiments, the housing 102 may include a plurality of keypad windows. Further, in some embodiments, the edge of the keypad window 110 may be finished (e.g., sanded, grinded, filed, rounded, polished, painted, powder coated, and/or stained). Due to its size, tools and finishing materials may have greater access to the edge, resulting in a more comprehensive finish and better lock durability. The keypad window 110 may be dimensioned and shaped to accommodate the bezel 108.

As shown in FIG. 1A, the keypad 106 may have a front side comprising respective faces of a plurality of depressible buttons. In certain embodiments, the respective faces of the plurality of depressible buttons may each define a surface (e.g., a continuous surface such as a plane, a convex surface, a concave surface, etc.). Alternatively, the respective faces may be individually raised and discrete (e.g., have respective faces that are discontinuous from other faces). In some embodiments, the keypad 106 may comprise an elastomeric membrane. For example, the keypad 106 may be a molded from a flexible, water-proof material (e.g., silicone or rubber) formed in a single continuous piece and comprising a plurality of buttons. By comprising, in various embodiments, a single, continuous, and waterproof membrane, the keypad 106 may help prevent water and dust intrusion into the lock's interior, as well as simplify manufacturing of the lock. Additionally, by reducing a ratio of seams-per-button, a continuous keypad 106 may prevent water and dust intrusion by having fewer joints that may leak (e.g., no leaking joints).

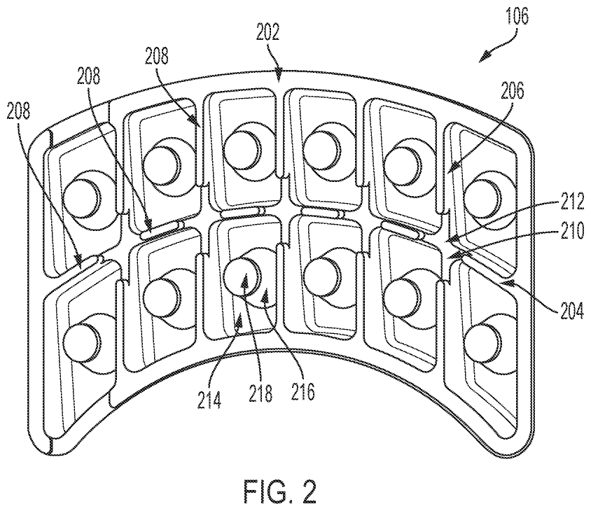

In certain embodiments, the keypad 106 may include one or more additional features to aid button functionality and reduce lock manufacturing costs. FIG. 2 illustrates a rear side of the keypad 106 according to various embodiments. As shown in FIG. 2, the keypad 106 may include a flexible support webbing positioned to bias one or more of (e.g., each of) the plurality of buttons outwardly from an interior of the lock (e.g., toward a front side of the lock) and thereby return each particular respective one of the one or more buttons to an unpressed position after the particular button has been depressed. These features may be incorporated into the keypad 106 in a single molding step, for instance.

The support webbing may include any one or more of multiple features to provide a biasing force capable of returning a depressed button to an unpressed position. For example, the support webbing may include a flexible perimeter wall 202. The perimeter wall may substantially or completely enclose a perimeter of the keypad and extend away from the lock's front side (e.g., toward the rear of the lock housing 102). In certain embodiments, the perimeter wall 202 may include one or more gaps, for instance to allow any water to drain, or to accommodate other components.

The support webbing may also or alternatively include a flexible interior wall disposed within the perimeter wall. In certain embodiments, the support webbing may include a plurality of flexible interior walls. For example, the support webbing may include a first flexible wall extending in a first direction, such as a horizontal wall 204. The support webbing may also include a second flexible wall extending in a second direction, such as vertical wall 206. In certain embodiments, the support webbing may include a plurality of such walls, such as the embodiment shown in FIG. 2 which has four walls parallel to the vertical wall 206. Additionally, the interior walls may include walls in any suitable layout or shape, and, in some embodiments, may not intersect the perimeter wall. For example, interior walls may form a substantially circular shape within a region defined by the perimeter wall 202.

The perimeter wall and the one or more interior walls may define a plurality of chambers, and each chamber of the plurality of chambers may correspond to a respective button of the plurality of buttons. For example, in certain embodiments, the keypad may include at least one top button and at least one bottom button. A perimeter wall of the keypad may outline a perimeter of the top and bottom buttons and enclose a volume. An interior wall may divide the volume into a top chamber and a bottom chamber corresponding to and having substantially the same cross section and shape as, the combined shape of the various top and bottom buttons. In a particular embodiment, the keypad 106 of FIG. 1 has twelve buttons. Accordingly, in the illustrated embodiment, the support webbing may provide twelve chambers, each corresponding to a respective button of the twelve buttons. The walls may thus be arranged in a grid pattern at least substantially corresponding to a grid pattern of the buttons of the keypad 106. For example, as shown in FIG. 2, the horizontal wall 204, the perimeter wall 202, and five vertical walls 206 cooperate to form twelve chambers, such as chamber 214.

Further, the walls that surround a particular chamber may cooperate to bias a particular one of the plurality of buttons corresponding to the particular chamber toward an (e.g., to) unpressed position. For instance, a portion of the perimeter wall 202, a portion of the horizontal wall 204, and portions of two vertical walls, each bordering the chamber 214, may cooperate to bias a button corresponding to the chamber 214 (i.e., the button numbered “9” on keypad 106) toward an unpressed position. In this way, for example, the walls may cooperate to return the button to an unpressed position after a user depresses the button. Further, the walls may be arranged in an array (e.g., a grid) having a regular spacing between walls. For example, vertical walls of the support webbing may have regular (e.g., substantially equal) spacing. In this way, the support webbing may provide a consistent biasing force across each of the plurality of buttons. For instance, in some embodiments, respective forces provided by an array of elastomeric biasing members of the support webbing (e.g., walls) at a center of respective buttons in a depressed position may lie within a range of an average of the respective forces (e.g., between 90% and 110%).

The perimeter wall and the interior wall or walls may also cooperate with a support structure (e.g., a portion of the lock supporting the keypad) in order to produce a force that biases one or more of the buttons toward an unpressed position. For example, when a user presses one of the buttons, the pressing force may compress the flexible walls against a support structure that supports the keypad. When the pressing force is removed, the walls may decompress and thereby return the button to an undepressed position. In certain embodiments, the perimeter wall may contact the support structure, for instance to seal against the support structure and prevent water entering behind the keypad 106. Further, the interior wall may contact the support structure as well, and aid in providing the biasing force. For instance, a rearward portion of the interior wall may have a rearmost surface that is at least substantially coplanar with a rearmost surface of the perimeter wall. The rearward portion may be dimensioned (e.g., have a depth) so as to cooperate with a rear support structure to provide a longitudinal force (e.g., a biasing force) toward the front side of the keypad 106. In some embodiments, substantially all of (e.g., all of) the entire interior wall may comprise a rearward portion, such that the entire interior wall contacts the support surface. In other embodiments, only certain portions of the interior wall may contact the support surface, while other inward portions do not contact the support surface.

For example, FIG. 2 illustrates exemplary positioning of rearward portions 208 on the interior walls. For instance, the horizontal wall 204 (i.e., a first wall) may include multiple rearward portions 208 that may be, for instance, arranged to align with the chambers, such as chamber 214. The horizontal wall 204 may also include inward portions, such as inward portion 210, which may lie between the rearward portions 208. The vertical wall 206 (i.e., a second wall) may also have a rearward portion having a rearmost surface that is at least substantially coplanar with (e.g., coplanar with) a rearmost surface of the perimeter wall, as well as an inward portion with a rearmost surface closer to the front side than the rearmost surface of the perimeter wall. The inward portions may have a rearmost surface closer to the front side than the rearmost surface of the perimeter wall. In this manner, a gap may be present between the support structure and an inward portion of the support webbing.

Further, in certain embodiments, one or more respective vertical walls 206 and one or more respective horizontal walls 204 may meet at an intersection 212. In the embodiment shown, an inward portion of a particular horizontal wall 204 and an inward portion of a respective vertical wall 206 meet at the intersection 212. In certain embodiments having a plurality of vertical walls (i.e., second walls), the vertical walls may respectively meet the horizontal wall 204 (i.e., the first wall) at respective intersections, as shown in FIG. 2. In this manner, one or more spaces may be present between the support webbing and the support structure to accommodate features on the support structure, as will be described below.

In various embodiments, each chamber (e.g., chamber 214) may house a structure that is configured to engage a component of a circuit board when a corresponding button is pressed. In this way, a signal may be initiated when a particular button on the keypad 106 is depressed. The signal may facilitate causing an electromechanical mechanism to unlock or lock a door. Thus, in some embodiments, the keypad 106 may include an elongated member, such as a stalk 216, disposed in each chamber of the plurality of chambers. The elongated member may extend rearward relative to the front side of the keypad. A conductive pad 218 may be disposed at a distal end of the elongated member. The conductive pad 218 may be positioned and dimensioned to selectively bridge an electrical connection within a circuit. When the conductive pad 218 bridges an electrical connection, it may indicate that the particular button corresponding to the particular chamber has been depressed.

In certain embodiments, the circuit may be disposed on a circuit board disposed behind the support webbing relative to the front side of the keypad 106. The circuit board may make up at least part, or all, of the rear support structure supporting the perimeter wall 202 and the rearward portions 208 of the support webbing. For instance, the perimeter wall 200 and rearward portions 208 of the support webbing may contact the circuit board, and the circuit board may provide structural support holding the keypad 106 in the keypad window 110.

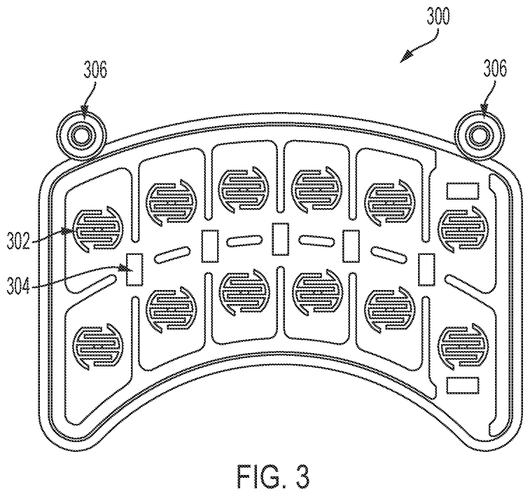

A circuit board 300 according to various embodiments of the present disclosure is shown in FIG. 3. The circuit board 300 may include a plurality of contacts, such as contact 302. The contact 302 may include one or more exposed electrodes. The contact 302 may be configured to pass an electrical signal in response to a conductive pad 218 bridging a gap between the exposed electrodes. In response, a microcontroller connected to the contact may register that a button was pressed and cause an electromechanical locking mechanism to lock or unlock a door (e.g., in response to a predefined combination of buttons being depressed—e.g., in sequence and/or simultaneously).

The circuit board may also include one or more light emitting diodes (LEDs), such as LED 304. The LED 304 may be disposed in an LED region on the circuit board 300. In an assembled state wherein the circuit board 300 secures the keypad 106 in the housing 102, the LED 304 may face an intersection (e.g., the intersection 212). The LED region may face an inward portion of the interior wall of the support webbing in this assembled state such that when a button is pressed, the support webbing does not contact the LED in the LED region.

Further, one or more fastener mounts 306 may each be positioned to accept a fastener (e.g., screw, bolt, pin, or any other suitable fastener), and the fastener may secure into a boss or other receiver in the housing 102. Tension on a fastener spanning between the fastener mount 306 and the housing 102 may cause pressure that compresses the circuit board against rearward portions of the support webbing, including the perimeter wall 202 and the rearward portions 208. However, inward portions 210 (e.g., at the intersection 212) may remain separated from circuit board 300 even when a button of the keypad 106 is depressed, providing clearance to avoid damaging the LED 304.

Additionally, since the LED 304 may be positioned opposite an inward portion, the LED 304 may illuminate a chamber adjacent to the LED region. Further, the LED 304 may face an inward portion, such as inward portion 210, that borders two or more chambers. In this configuration, one LED may illuminate a plurality of adjacent chambers which are, for instance, connected by a gap formed between an inward portion (e.g., the inward portion 210) and the support structure (e.g., the circuit board 300). For example, in an assembled state wherein the circuit board 300 secures the keypad 106 in place relative to the lock, the LED 304 may lie in the intersection 212. Light produced by the LED 304 may illuminate the four chambers adjacent to the intersection 212 (e.g., the chambers corresponding to buttons numbered “1”, “2”, “6”, and “7” on the keypad 106). Additionally, the keypad may be at least partially transparent so that buttons corresponding to the plurality of adjacent chambers illuminate in response to the LED illuminating the plurality of adjacent chambers.

Further, the circuit board may include a plurality of LEDs disposed in respective LED regions corresponding to respective intersections. Thus, a total number of LEDs on the circuit board may be less than a total number of buttons on the keypad. For example, as shown in FIG. 3, the circuit board 300 includes seven LEDs 304 (each represented by a similarly sized rectangle in the figure). However, the keypad 106 includes twelve buttons. Accordingly, the circuit board 300 may be manufactured with fewer components than if each chamber were enclosed by a perimeter wall and multiple interior walls with no inward portions 210, which might therefore require one LED for each chamber.

As discussed above, in certain embodiments, the keypad 106 may engage with a bezel 108 providing additional structural support to buttons of the keypad 106, for instance in a vertical and/or a horizontal direction. The bezel 108 may also aid in providing a water and dust resistant seal between the keypad 106 and the circuit board 300.

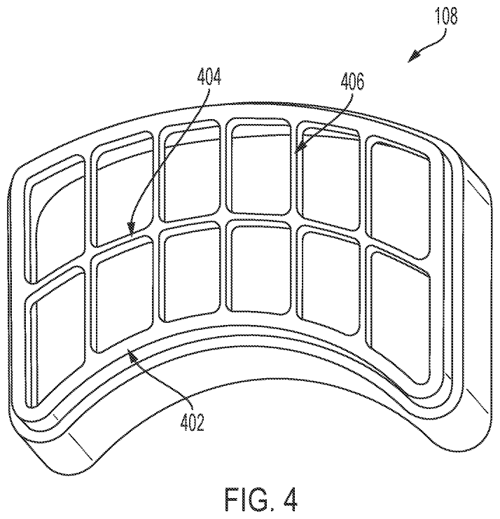

FIG. 4 illustrates a bezel 108 according to various embodiments of the present disclosure. As shown in FIG. 4, the bezel 108 may comprise a frame 402 that surrounds the keypad 106. The frame may be configured to mate with a perimeter of the keypad window 110. For example, as shown in an assembled state in FIG. 1A, the bezel 108 may at least partially (e.g., partially or entirely) lie between buttons of the keypad 106 and the housing 102. Thus, respective outer surfaces of the plurality of depressible buttons may be separated from the perimeter of the keypad window by the frame 402.

The bezel 108 may also include one or more spars, such as horizontal spars 404 and vertical spars 406 that outline each of the plurality of buttons on the keypad 106. The horizontal spars 404 and vertical spars 406 may, for instance, provide a guiding force so that when a user presses a button, the button travels inwardly without substantial movement (e.g., any movement) vertically or horizontally. For instance, in some cases, if the button were to move vertically and/or horizontally when pressed, the conductive pad 218 may miss the contact 302 and not initiate a signal to unlock or lock a door. Thus, the spars of the bezel 108 may help ensure that the conductive pads 218 reliably make contact with the circuit board 300. Further, the spars may help scrape water and/or dust off of the sides of the buttons during movement. In this way, the buttons of the keypad 106 may have support provided by a single-piece bezel 108, which may be aligned together and inserted into the keypad window 110.

Additionally, in certain embodiments, the keypad 106 may include a sealing flange, such as a flange lying in a plane perpendicular to the longitudinal reaction force, and/or parallel to a plane of the circuit board 300. The sealing flange may be positioned to prevent water from entering a volume between the keypad 106 and the circuit board 300. The frame 402 of the bezel 108 may compress a flange of the keypad against a support structure (e.g., the circuit board 300) to create a substantially (e.g., completely) water-tight seal. This may help provide a consistent pressure, for instance, if the housing 102 has a curved profile.

Accordingly, features of various embodiments of the present disclosure may simplify assembly of an electronic door lock, reducing assembly time, supply chain complexity, and cost. For example, a keypad window (e.g., keypad window 110) may be formed in a lock housing (e.g., housing 102) by a punch, cut, or other suitable technique, producing one perimeter edge that may be rounded and polished. The bezel 108 may then be aligned with and inserted into the keypad window 110. Further, the plurality of buttons of the keypad 106 may be aligned with respective spaces between the plurality of spars and inserted into the keypad window 110. Thus, the keypad window 110 may help guide the bezel 108 into alignment, and the bezel 108 may help guide the keypad 106 into alignment, allowing fast, precise assembly. Further, with the bezel 108 and keypad 106 in place, the webbing recesses (e.g., inward portions 210) of the keypad 106 may be aligned with respective LEDs disposed on a circuit board. The bezel 108, the keypad 106, and the circuit board 300 may then be secured to the housing 102. For example, a fastener may protrude through a fastener mount 306 on the circuit board 300, past or through the keypad 106 and the bezel 108, and into a boss on an interior surface of the housing 102. The fastener may thereby provide pressure to seal the keypad 106 against the interior surface of the housing 102 and a surface of the circuit board 300 to prevent water intrusion and extend the life of the electronic door lock.

### CONCLUSION

Many modifications and other embodiments of the disclosure will come to mind to one skilled in the art to which this disclosure pertains having the benefit of the teachings presented in the foregoing descriptions and the associated drawings. For example, as will be understood by one skilled in the relevant field in light of this disclosure, the embodiments may take form in a variety of different mechanical and operational configurations. Therefore, it is to be understood that the disclosure is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

We claim:

1. An electronic door lock comprising:
a housing having a keypad window;
a keypad inserted into the keypad window and having a plurality of depressible buttons; and
a bezel surrounding the keypad and having a spar, the spar lying between the buttons and providing support to the plurality of depressible buttons in a direction substantially perpendicular to a press direction.

2. The electronic door lock of claim 1, wherein the keypad is a single continuous member comprising:
a front side comprising respective faces of the plurality of depressible buttons; and
a rear side having a flexible support webbing positioned to bias each of the plurality of buttons toward the front side and return each of the plurality of buttons to an unpressed position after being depressed.

3. The electronic door lock of claim 2, wherein the support webbing comprises:
a perimeter wall substantially enclosing a perimeter of the keypad and extending away from the front side; and
an interior wall disposed within the perimeter wall; wherein:
the perimeter wall and the interior wall define a plurality of chambers, each chamber of the plurality of chambers corresponding to a respective button of the plurality of buttons; and
a portion of the perimeter wall and a portion of the interior wall bordering a particular chamber cooperate to bias a particular one of the plurality of buttons corresponding to the particular chamber to an unpressed position.

4. The electronic door lock of claim 3, wherein:
a rearward portion of the interior wall has a rearmost surface coplanar with a rearmost surface of the perimeter wall and dimensioned so as to cooperate with a rear support structure to provide a longitudinal force toward the front side; and
an inward portion of the interior wall has a rearmost surface closer to the front side than the rearmost surface of the perimeter wall.

5. The electronic door lock of claim 4, wherein the keypad further comprises:
an elongated member disposed in each chamber of the plurality of chambers, the elongated member extending rearward relative to the front side of the keypad; and
a conductive pad disposed at a distal end of the elongated member and positioned and dimensioned to selectively bridge an electrical connection within a circuit to electronically indicate that the particular button corresponding to the particular chamber has been depressed.

6. The electronic door lock of claim 4, further comprising a circuit board configured to contact the perimeter wall and the at least one rearward portion of the interior wall, the circuit board being at least part of the rear support structure.

7. The electronic door lock of claim 6, wherein the circuit board comprises an LED disposed in a LED region facing the at least one inward portion of the interior wall and positioned so as to illuminate an adjacent chamber.

8. The electronic door lock of claim 7, wherein:
the interior wall is a first wall extending in a first direction;
the support webbing further comprises a second wall extending in a second direction;
a rearward portion of the second wall has a rearmost surface coplanar with a rearmost surface of the perimeter wall;
an inward portion of the second wall has a rearmost surface closer to the front side than the rearmost surface of the perimeter wall; and
the inward portion of the second wall and the inward portion of the first wall meet at an intersection.

9. The electronic door lock of claim 8, wherein the LED region faces the intersection, and the LED is positioned so as to illuminate a plurality of adjacent chambers.

10. The electronic door lock of claim 9, wherein the keypad is at least partially transparent and buttons corresponding to the plurality of adjacent chambers illuminate in response to the LED illuminating the plurality of adjacent chambers.

11. The electronic door lock of claim 9, wherein:
the support webbing further comprises a plurality of second walls, respectively meeting the first wall at respective intersections; and
the circuit board comprises a plurality of LEDs disposed in respective LED regions corresponding to the respective intersections.

12. The electronic door lock of claim 11, wherein a number of LEDs on the circuit board is less than a number of buttons on the keypad.

13. The electronic door lock of claim 1, wherein faces of the plurality of depressible buttons define a surface.

14. The electronic door lock of claim 1, wherein the bezel comprises:
a frame configured to mate with a perimeter of the keypad window and compress a flange of the keypad against a support structure to create a water-tight seal; and
a plurality of spars configured to lie between depressible buttons of the plurality of depressible buttons and configured to provide vertical and horizontal support to the buttons.

15. The electronic door lock of claim 14, wherein respective outer surfaces of the plurality of depressible buttons are separated from the perimeter of the keypad window by the frame.

16. The electronic door lock of claim 1, wherein the keypad comprises an elastomeric membrane.

17. A method of manufacturing an electronic door lock comprising:
forming a keypad window in a lock housing;
inserting a bezel into the keypad window, the bezel comprising a plurality of spars;
aligning a plurality of buttons of a keypad with respective spaces between the plurality of spars;
inserting the keypad into the keypad window;
aligning webbing recesses of the keypad with respective LEDs disposed on a circuit board; and
securing the bezel, the keypad, and the circuit board to the lock housing.

18. The method of claim 17, further comprising:
rounding a perimeter edge of the keypad window; and
polishing the perimeter edge.

19. The method of claim 17, further comprising:
inserting a fastener through the circuit board, past the keypad and the bezel, and into a boss on an interior surface of the lock housing.

20. An electronic door lock comprising:
a lock body having a keypad window and substantially defining an interior volume;
an elastomeric keypad disposed in the keypad window, the elastomeric keypad comprising:
a plurality of buttons;
an integrated webbing configured to provide a longitudinal reaction force to return a particular button of the plurality of buttons to a non-depressed orientation in response to the particular button being pressed; and
a sealing flange substantially lying in a plane perpendicular to the longitudinal reaction force; and
a circuit board disposed in the interior volume and comprising an LED; wherein the elastomeric keypad contacts the circuit board; and
the sealing flange is positioned to prevent water from entering a volume between the elastomeric keypad and a circuit board behind the elastomeric keypad.

21. The electronic door lock of claim 20, wherein the circuit board comprises a plurality of LEDs positioned on the circuit board and within the volume to illuminate each of the plurality of buttons.

22. The electronic door lock of claim 20, wherein a number of windows on the lock body is less than a number of buttons on the keypad.

23. The electronic door lock of claim 20, wherein a number of LEDs on the circuit board is less than a number of buttons on the keypad.

24. The electronic door lock of claim 20, wherein the keypad further comprises an elongated member connected to a button and terminating with a conductive pad, the conductive pad being configured to contact the circuit board when the button is depressed to complete a circuit and initiate a signal to facilitate unlocking the electronic door lock.

25. The electronic door lock of claim 20, wherein the integrated webbing comprises an array of elastomeric biasing members arranged in a grid pattern, the grid pattern of the integrated webbing matching a grid pattern of the plurality of buttons.

26. The electronic door lock of claim 25, wherein respective forces provided by the array of elastomeric biasing members at a center of respective buttons in a depressed position lie within a range between 90% and 110% of an average of the respective forces.
